(19) United States
(12) Patent Application Publication
(10) Pub. No.: US 2021/0240059 A1
(43) Pub. Date: Aug. 5, 2021

(54) IMAGING METHOD AND IMAGING SYSTEM

(71) Applicant: SZ DJI TECHNOLOGY CO., LTD., Shenzhen (CN)

(72) Inventors: Tianhang MA, Shenzhen (CN); Tao ZHAO, Shenzhen (CN)

(21) Appl. No.: 17/234,508

(22) Filed: Apr. 19, 2021

Related U.S. Application Data
(63) Continuation of application No. PCT/CN2018/118029, filed on Nov. 28, 2018.

(51) Int. Cl. G03B 17/56; F16M 11/12; F16M 11/20

(52) U.S. Cl. CPC G03B 17/563; F16M 11/205; F16M 11/123

(57) ABSTRACT

An imaging method includes when an amount of incident light is less than a preset value, controlling a gimbal carrying an imaging device to enter a stabilization mode, controlling the imaging device to perform imaging with a second exposure duration longer than a first exposure duration. The imaging device is used to perform imaging with the first exposure duration when the amount of incident light is greater than the preset value.

### CROSS-REFERENCE TO RELATED APPLICATION

This application is a continuation of International Application No. PCT/CN2018/118029, filed Nov. 28, 2018, the entire content of which is incorporated herein by reference.

### TECHNICAL FIELD

The present disclosure relates to the field of imaging technology and, in particular, to an imaging method and an imaging system.

### BACKGROUND

When an existing imaging device shoots in a dark environment, an amount of exposure is increased by increasing a sensitivity of the imaging device. However, increasing the sensitivity may cause more noise in a scene image captured by the imaging device, thereby causing a poor imaging effect in a dark environment.

### SUMMARY

In accordance with the disclosure, there is provided an imaging method including when an amount of incident light is less than a preset value, controlling a gimbal carrying an imaging device to enter a stabilization mode, controlling the imaging device to perform imaging with a second exposure duration longer than a first exposure duration. The imaging device is used to perform imaging with the first exposure duration when the amount of incident light is greater than the preset value.

Also in accordance with the disclosure, there is provided an imaging system including a gimbal used to enter a stabilization mode when an amount of incident light is less than a preset value, and an imaging device mounted at the gimbal and used to perform imaging at a first exposure duration when the amount of incident light is greater than the preset value, and perform imaging at a second exposure duration longer than the first exposure duration when the amount of the incident light is less than the preset value and the gimbal enters the stabilization mode.

### BRIEF DESCRIPTION OF THE DRAWINGS

FIG. 1 is a perspective view of an imaging system consistent with embodiments of the disclosure.

FIG. 2 to FIG. 5 are schematic flow charts of imaging methods consistent with embodiments of the disclosure.

FIG. 6 to FIG. 9 are schematic diagrams showing locking duration and a second exposure duration consistent with embodiments of the disclosure.

FIG. 10 to FIG. 12 are schematic flow charts of imaging methods consistent with embodiments of the disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The terms “first” and “second” are used for descriptive purposes only and should not be understood as indicating or implying relative importance or implicitly indicating the number of technical features indicated. Thus, a feature described with “first” or “second” may include one or more of such feature explicitly or implicitly. In the description of the present disclosure, “multiple” or “plurality of” means two or more, unless otherwise specified.

In the description of the present disclosure, unless otherwise defined and specified, the term “mount,” “connect,” and “communication” should be understood broadly. For example, a connection may be a fixed connection or a detachable connection, or a whole; it may be a mechanical connection, or may be an electrical connection, or may be a communication with each other; it may be a direct connection, or may be an indirect connection via an intermediate medium, or may be an internal connection of two components or the interaction between two components. For persons of ordinary skill in the art, the specific meaning of the above terms in the present disclosure can be understood according to the specific circumstances.

To simplify the disclosure, the components and settings of specific examples are described below, which are not intended to limit the disclosure. In addition, reference numerals and/or reference letters may be repeated in different embodiments of the present disclosure. Such repetition is for the purpose of simplification and clarity and does not indicate the relationship between the various embodiments and/or settings discussed. In addition, various specific processes and materials are provided in the embodiments of the present disclosure, but those of ordinary skill in the art may be aware of the application of other processes and/or the use of other materials.

The embodiments of the present disclosure are described in detail below with reference to the drawings, in which the same or similar reference numerals indicate the same or similar components or components with the same or similar functions. The following embodiments described with reference to the drawings are exemplary, and are used to explain the present disclosure only, but should not be understood as a limitation to the present disclosure.

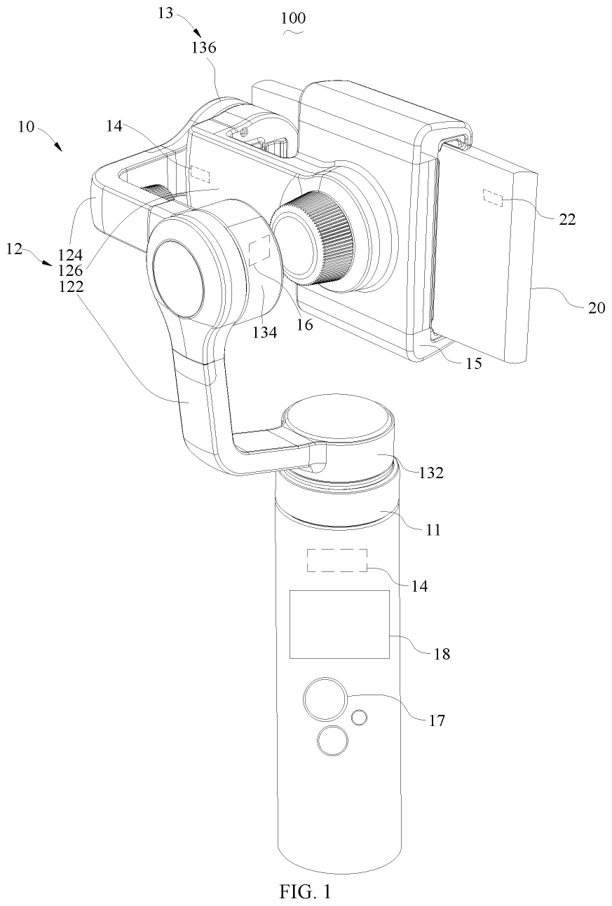

FIG. 1 is a perspective view of an imaging system 100 consistent with embodiments of the disclosure. As shown in FIG. 1, the imaging system 100 includes a gimbal 10 and an imaging device 20. The imaging device 20 is mounted at the gimbal 10.

The gimbal 10 includes a handle 11, a shaft frame 12, a motor assembly 13, an inertial measurement unit 14, a bracket 15, and a joint angle assembly 16. At least one shaft frame 12 is included, is mounted at the handle 11, and is used to carry the imaging device 20.

The gimbal 10 may include a handheld gimbal or a gimbal 10 arranged at an unmanned aerial vehicle (UAV). The following descriptions are made by taking the gimbal 10 including a handheld gimbal as an example. The principle of the gimbal 10 including a gimbal 10 arranged at a UAV is similar to the principle of the gimbal 10 including a handheld gimbal, which is omitted here. The imaging device 20 may be a camera built in the handheld gimbal, or may be an external device, such as a mobile phone, a tablet, etc.

Specifically, the shaft frame 12 includes at least one of a yaw shaft frame 122, a roll shaft frame 124, or a pitch shaft frame 126. When the shaft frame 12 includes any one of the yaw shaft frame 122, the roll shaft frame 124, and the pitch shaft frame 126, the gimbal 10 is a single-axis handheld gimbal. When the shaft frame 12 includes any two of the yaw shaft frame 122, the roll shaft frame 124, and the pitch shaft frame 126, the gimbal 10 is a two-shaft handheld gimbal. When the shaft frame 12 includes the yaw shaft frame 122, the roll shaft frame 124, and the pitch shaft frame 126, the gimbal 10 is a three-axis handheld gimbal. As shown in FIG. 1, the gimbal 10 is a three-axis handheld gimbal. The following descriptions are made by taking the gimbal 10 including a three-axis handheld gimbal as an example. The principle of the gimbal 10 includes a single-axis handheld gimbal or a two-shaft handheld gimbal are similar to the principle of the gimbal 10 including a three-axis handheld gimbal, which is omitted here.

The motor assembly 13 includes a yaw shaft motor 132, a roll shaft motor 134, and a pitch shaft motor 136. The yaw shaft frame 122 is mounted at the handle 11, the roll shaft frame 124 is mounted at the yaw shaft frame 122, and the pitch shaft frame 126 is mounted at the roll shaft frame 124. The yaw shaft motor 132 is mounted at the handle 11 and is used to control rotation of the yaw shaft frame 122, the roll shaft motor 134 is mounted at the yaw shaft frame 122 and is used to drive the roll shaft frame 124 to rotate, and the pitch shaft motor 136 is mounted at the roll shaft frame 124 and is used to drive the pitch shaft frame 126 to rotate. The structure of the shaft frame 12 consistent with the embodiments of the present disclosure is not limited here, and the yaw shaft frame 122, the roll shaft frame 124, and the pitch shaft frame 126 may also be connected in another order.

The inertial measurement unit 14 is arranged at the shaft frame 12. For example, one inertial measurement unit 14 is arranged at the shaft frame 12. Specifically, the inertial measurement unit 14 is arranged at the pitch shaft frame 126, and the inertial measurement unit 14 may detect current attitudes of the yaw shaft motor 132, the roll shaft motor 134, and the pitch shaft motor 136. The inertial measurement unit 14 may also cooperate with the joint angle assembly 16 to calculate the attitude of the handle 11 according to the attitude and joint angle data of the imaging device 20. Alternately, two inertial measurement units 14 are arranged at the handle 11 and the shaft frame 12, respectively. Specifically, the two inertial measurement units 14 are arranged at the handle 11 and the pitch shaft frame 126, respectively. The inertial measurement unit 14 may detect the current attitude of the handle 11, the yaw shaft frame 122, the roll shaft frame 124, and the pitch shaft frame 126. The inertial measurement unit 14 may also be arranged in another suitable position. In an example embodiment, two inertial measurement units 14 are arranged at the handle 11 and the pitch shaft frame 126, respectively. Further, the inertial measurement unit 14 includes at least one of an accelerometer or a gyroscope.

The bracket 15 is mounted at the pitch shaft frame 126 and is used to mount and fix the imaging device 20.

The joint angle assembly 16 is arranged at the motor assembly 13 of the gimbal 10 to obtain a joint angle of the motor assembly 13. The joint angle assembly 16 includes one or more of a potentiometer, a Hall sensor, and a magnetic encoder. For example, in an example embodiment, for a three-axis gimbal, each of the yaw shaft motor 132, the roll shaft motor 134, and the pitch shaft motor 136 corresponds to a joint angle assembly 16. In some embodiments, there is no need to set an inertial measurement unit 14 at the handle 11 to detect a current attitude of the handle 11. The current attitude of the handle 11 can be calculated according to the joint angle of the motor assembly 13 and the current attitude of the shaft frame 12, which can reduce a number of the inertial measurement unit 14 and save cost. The above-described method is only a schematic description of how to obtain a current attitude of the handle 11, which is not limited here.

The gimbal 10 includes at least a stabilization mode and a following mode.

The stabilization mode refers to that the gimbal 10 always keeps the imaging device 20 at a stable attitude, and the stable attitude is usually a three-axis orthogonal zero position. Specifically, the gimbal 10 keeps the imaging device 20 to be stationary relative to a geodetic coordinate system by rotating the shaft frame 12. Under the stabilization mode, the gimbal 10 performs a negative feedback adjustment on an operation of a user to offset possible shaking, thereby keeping the imaging device 20 to be stationary relative to the geodetic coordinate system (that is, at a stable attitude). Under the stabilization mode, when the user operates the handheld gimbal to cause the handle 11 to pitch a certain angle, the imaging device 20 may still maintain an original imaging angle (usually a three-axis orthogonal zero position) rather than pitch accordingly. This is because when the handle 11 pitches, the pitch shaft frame 126 of the gimbal 10 performs a negative feedback adjustment to keep the imaging device 20 mounted at the gimbal 10 to be at a zero position of a pitch axis. The negative feedback adjustment of the pitch shaft frame 126 specifically includes that the gimbal 10 controls the imaging device 20 to pitch a corresponding angle in an opposite direction to stabilize the pitch shaft frame 126, thereby keeping the imaging device 20 at the zero position of the pitch axis. Similarly, under the stabilization mode, when the user operates the handheld gimbal to cause the handle 11 to roll a certain angle, the imaging device 20 may still maintain the original imaging angle (usually a three-axis orthogonal zero position) rather than roll accordingly. This is because when the handle 11 rolls, the roll shaft frame 124 of the gimbal 10 performs a negative feedback adjustment to keep the imaging device 20 mounted at the gimbal 10 at the zero position of a roll axis. The negative feedback adjustment performed by the roll shaft frame 124 specifically includes that the gimbal 10 controls the imaging device 20 to roll a corresponding angle in an opposite direction to stabilize the roll shaft frame 124, thereby keeping the imaging device 20 at the zero position of the roll axis. Similarly, under the stabilization mode, when the user operates the handheld gimbal to cause the handle 11 to yaw a certain angle, the imaging device 20 may still maintain the original imaging angle (usually a three-axis orthogonal zero position) rather than yaw accordingly. This is because when the handle 11 yaws, the yaw shaft frame 122 of the gimbal 10 performs a negative feedback adjustment to keep the imaging device 20 mounted at the gimbal 10 at the zero position of a yaw axis. The negative feedback adjustment performed by the yaw shaft frame 122 specifically includes that the gimbal 10 controls the imaging device 20 to yaw a corresponding angle in an opposite direction to stabilize the yaw shaft frame 122, thereby keeping the imaging device 20 at the zero position of the yaw axis.

The following mode refers to that the gimbal 10 keeps a relative angle between the imaging device 20 and the corresponding shaft frame 12 unchanged to follow the shaft frame 12 to rotate, or keeps the relative angle between the imaging device 20 and the handle 11 unchanged to follow the handle 11 to rotate. For example, if the user controls the handle 11 to pitch up 15 degrees, the gimbal 10 controls the pitch shaft frame to pitch up 15 degrees to keep the relative angle between the imaging device 20 and the handle 11 approximately unchanged. If the user controls the handle 11 to pitch down 15 degrees, the gimbal 10 control the pitch shaft frame to pitch down 15 degrees to keep the relative angle between the imaging device 20 and the handle 11 approximately unchanged. When the gimbal 10 maintains the stabilization mode, maintains the following mode, or switches between the stabilization mode and the following mode, the gimbal 10 may simultaneously perform maintaining the stabilization mode, maintaining the following mode, or switching between the stabilization mode and the following mode on a plurality of shaft frames 12. The gimbal 10 may also individually perform maintaining the stabilization mode, maintaining the following mode, or switching between the stabilization mode and the following mode on each shaft frame 12. In the embodiments of the present disclosure, the gimbal 10 individually performs maintaining the stabilization mode, maintaining the following mode, or switching between the stabilization mode and the following mode on each shaft frame 12.

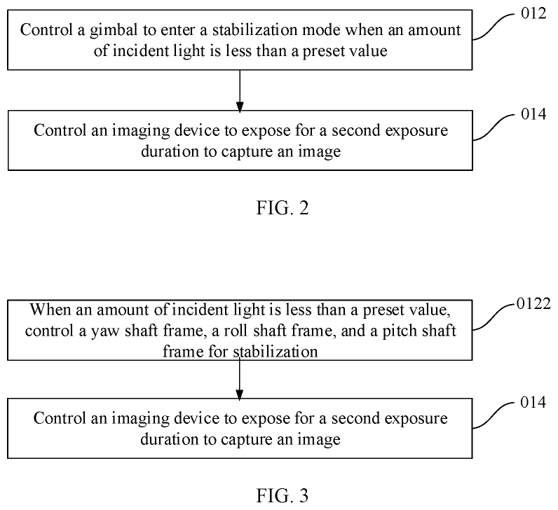

FIG. 2 to FIG. 5 are schematic flow charts of imaging methods consistent with embodiments of the disclosure.

In an example embodiment, when an amount of incident light incident on the imaging device 20 is greater than a preset value, the imaging device 20 may expose for a first exposure duration to capture a scene image. As shown in FIG. 2, the imaging method of the imaging system 100 consistent with embodiments of the present disclosure includes following processes.

At 012, the gimbal 10 is controlled to enter the stabilization mode when the amount of incident light is less than the preset value.

At 014, the imaging device 20 is controlled to expose for a second exposure duration longer than the first exposure duration to capture a scene image. That is, the imaging device 20 is controlled to perform imaging with the second exposure duration.

In some embodiments, when the amount of incident light is less than the preset value, the gimbal 10 enters the stabilization mode. The imaging device 20 exposes for the second exposure duration to capture a scene image. The second exposure duration is longer than the first exposure duration.

That is, process 012 may be realized by the gimbal 10, process 014 may be realized by the imaging device 20.

Specifically, the amount of incident light is related to brightness of ambient light and an aperture value. When the aperture value is a constant, the amount of incident light increases as the brightness of the ambient light of the imaging scene increases. The amount of incident light consistent with the embodiments of the present disclosure refers to an amount of light incident on the imaging device 20 per unit time. The imaging device 20 generally includes an image sensor 22, for example, a charge coupled device (CCD) or a complementary metal oxide semiconductor (CMOS). The amount of incident light per unit time can be detected by the image sensor 22. When the amount of incident light is greater than the preset value, the light is relatively sufficient, and the imaging device 20 can expose for the first exposure duration to capture a scene image (one frame), i.e., the imaging device 20 can perform imaging with the first exposure duration. The preset value refers to the amount of light received per unit time by the image sensor 22 when the light is relatively sufficient. Because the light is relatively sufficient, the first exposure duration does not need to be relatively long to enable the image sensor 22 to obtain enough light to capture a clear scene image. For example, the first exposure duration is ⅛ second, or 1/16 second, etc.

The imaging device 20 and the gimbal 10 can communicate with each other. The communication manner may include a wired connection (such as a USB connection) or a wireless connection (such as a Bluetooth connection), which is not limited here.

When the amount of incident light is less than the preset value, after the image sensor 22 sends a signal to the gimbal 10 indicating that the amount of incident light is less than the preset value, the gimbal 10 enters the stabilization mode. In some embodiments, the imaging device 20 controls the gimbal 10 to enter the stabilization mode after receiving a signal from the image sensor 22 indicating that the amount of incident light is less than the preset value.

When the gimbal 10 is under the stabilization mode, the gimbal 10 can always keep the imaging device 20 at a stable attitude by rotating the shaft frame 12. In this scenario, the imaging device 20 exposes for the second exposure duration to capture a scene image. Because the amount of incident light is less than the preset value, it is in a dark environment. If the imaging device 20 exposes for the first exposure duration to capture a scene image, the amount of light may be insufficient, causing the scene image to be not clear. Therefore, the imaging device 20 exposes for a second exposure duration longer than the first exposure duration. Because the total amount of light required by the image sensor 22 for imaging is approximately constant when a sensitivity is a constant, after the amount of incident light per unit time is reduced, the image sensor 22 can obtain sufficient light by extending the exposure duration. For example, the second exposure duration may be set as any value longer than ⅛ second, such as 1 s, 2 s, 3 s, 4 s, 5 s, 6 s, 7 s, 8 s, etc. In some embodiments, the second exposure duration may be set as any value from 3 s to 8 s, for example, 3 s, 4 s, 5.5 s, 6 s, 7 s, 8 s, etc. Moreover, because the gimbal 10 is under the stabilization mode, when the imaging device 20 exposes for the second exposure duration to capture a scene image, the gimbal 10 may offset shaking by a user to keep the imaging device 20 at a stable attitude. That is, the imaging device 20 can not only obtain sufficient light by exposing for the second exposure duration to capture a scene image and ensure imaging quality, but also be kept at a stable attitude by the gimbal 10 to avoid a problem of blurring of the captured scene image due to the shaking by the user. In addition, the gimbal 10 is a handheld gimbal, which can perform stable imaging without using a tripod or another ponderous device, thereby achieving good portability.

The imaging method consistent with the embodiments of the present disclosure includes when the amount of incident light is less than the preset value, controlling the gimbal 10 to enter the stabilization mode and controlling the imaging device 20 to expose for the second exposure duration longer than the first exposure duration to capture a scene image, which can avoid increasing the sensitivity to ensure that the scene image has less noise. Because the imaging device 20 exposes for the second exposure duration, the imaging device 20 can obtain sufficient light to ensure the imaging quality. Moreover, because the gimbal 10 enters the stabilization mode, during the second exposure duration, the shaking of the imaging device 20 is offset by the stabilization of the gimbal 10, thereby preventing the scene image from becoming blurred, and further ensuring the imaging quality.

In some embodiments, the gimbal 10 includes a single-axis stabilization mode, a dual-axis stabilization mode, a three-axis stabilization mode, a following mode, and a tracking mode. The gimbal 10 can be switch between any two modes of the single-axis stabilization mode, dual-axis stabilization mode, three-axis stabilization mode, following mode, and tracking mode.

Specifically, the single-axis stabilization mode is that any one of the yaw shaft frame 122, the roll shaft frame 124, and the pitch shaft frame 126 is stabilized. For example, the yaw shaft frame 122 is separately stabilized, or the roll shaft frame 124 is separately stabilized, or the pitch shaft frame 126 is separately stabilized. The dual-axis stabilization mode is that any two of the yaw shaft frame 122, the roll shaft frame 124, and the pitch shaft frame 126 are stabilized. For example, both the yaw shaft frame 122 and the roll shaft frame 124 are stabilized, or both the yaw shaft frame 122 and the pitch shaft frame 126 are stabilized, or both the roll shaft frame 124 and the pitch shaft frame 126 are stabilized. The three-axis stabilization mode is that the yaw shaft frame 122, the roll shaft frame 124, and the pitch shaft frame 126 are all stabilized. In the embodiments of the present disclosure, when the amount of incident light is less than a preset value, the three shaft frames of the gimbal 10 are all stabilized, the imaging device 20 can always maintain a stable attitude (for example, a three-axis orthogonal zero position), and the stabilization effect is better. The following mode is that the roll shaft frame 124 is stabilized, and both the yaw shaft frame 122 and the pitch shaft frame 126 follow movement of the handle 11. The tracking mode is that the roll shaft frame 124 is stabilized, both the yaw shaft frame 122 and the pitch shaft frame 126 follow a target object to rotate to enable the imaging device 20 to always track and capture the target object. For example, if the target object moves to the left, then the yaw shaft frame 122 yaws to the left. For another example, if the target object moves upward, then the pitch shaft frame 126 pitches up.

The gimbal 10 can switch between any two modes of the single-axis stabilization mode, the dual-axis stabilization mode, the three-axis stabilization mode, the following mode, and the tracking mode. The gimbal 10 can also maintain a current working mode. In an example embodiment, the gimbal 10 can be under any one of the above-described modes before the amount of incident light is less than the preset value. For example, if the gimbal 10 is under the single-axis stabilization mode before the amount of incident light is less than the preset value (the amount of incident light is greater than or equal to the preset value), the gimbal 10 switches from the single-axis stabilization mode to the three-axis stabilization mode when the amount of incident light is less than the preset value. For another example, if the gimbal 10 is under the dual-axis stabilization mode before the amount of incident light is less than the preset value, the gimbal 10 switches from the dual-axis stabilization mode to the three-axis stabilization mode when the amount of incident light is less than the preset value. For another example, if the gimbal 10 is under the following mode before the amount of incident light is less than the preset value, the gimbal 10 switches from the following mode to the three-axis stabilization mode when the amount of incident light is less than the preset value. For another example, if the gimbal 10 is under the tracking mode before the amount of incident light is less than the preset value, the gimbal 10 switches from the tracking mode to the three-axis stabilization mode when the amount of incident light is less than the preset value. For another example, if the gimbal 10 is under the three-axis stabilization mode before the amount of incident light is less than the preset value, the gimbal 10 maintains the three-axis stabilization mode when the amount of incident light is less than the preset value. In either case, the imaging device 20 needs to be under the three-axis stabilization mode during the second exposure duration to prevent the captured scene image from being blurred due to the shaking by the user.

In some embodiments, the imaging device 20 can expose for the first exposure duration to capture a scene image when the amount of incident light is greater than the preset value, and the imaging device 20 can expose for the second exposure duration to capture a scene image when the amount of incident light is less than or equal to the preset value. Alternately, the imaging device 20 can expose for the first exposure duration to capture a scene image when the amount of incident light is greater than or equal to the preset value, and the imaging device 20 can expose for the second exposure duration to capture a scene image when the amount of incident light is less than the preset value. Therefore, the imaging method can be executed correctly when the amount of incident light is greater than, equal to, or less than the preset value.

In some embodiments, the gimbal 10 includes at least one shaft frame 12, and the shaft frame 12 includes a yaw shaft frame 122, a roll shaft frame 124, and a pitch shaft frame 126. As shown in FIG. 3, process 012 includes controlling the yaw shaft frame 122, the roll shaft frame 124, and the pitch shaft frame 126 for stabilization (process 0122).

In some embodiments, the gimbal 10 is used to control the yaw shaft frame 122, the roll shaft frame 124, and the pitch shaft frame 126 for stabilization.

That is, process 0122 can be realized by the gimbal 10.

Specifically, when the gimbal 10 enters the stabilization mode to keep the imaging device 20 to be stationary relative to the geodetic coordinate system (i.e., at a stable attitude), the gimbal 10 controls the yaw shaft frame 122, the roll shaft frame 124, and the pitch shaft frame 126 to be all stabilized. No matter which one or more operations of yaw, roll, and pitch are performed by the user, the gimbal 10 can perform one or more negative feedback adjustment to the operations of the user to offset possible shaking to keep the imaging device 20 to be always stationary relative to the geodetic coordinate system, thereby ensuring imaging stability of the imaging device 20.

In some embodiments, the second exposure duration can be manually set or adjusted by the user.

Specifically, as shown in FIG. 1, the second exposure duration can be manually set by the user, which can be set by operating a button 17 at the handle 11, or can be set by operating a touch screen 18 at the handle 11, or can be set by operating a button (not shown) at the imaging device 20, or can be set by operating on a touch screen (not shown) or a built-in control button (not shown) at the imaging device 20, or can be set by operating an external remote control (not shown) that communicates with the imaging device 20. The second exposure duration can be manually adjusted by the user refers that if the imaging system 100 exposes for the second exposure duration to capture a scene image, and the user finds that it is still dark after viewing it, the second exposure duration can be manually adjusted to be extend the exposure duration (the adjustment method is similar to the above-described setting method, which is omitted here). If the scene image with satisfactory brightness is not obtained after manually extending the exposure duration, the second exposure duration can be adjusted again until a more satisfactory scene image is obtained. Similarly, if the imaging system 100 exposes for the second exposure duration to capture a scene image, and the user finds that it is overexposed after viewing it, the second exposure duration can manually adjust to shorten the exposure duration (the adjustment method is similar to the above-described setting method, which is omitted here). If the scene image with satisfactory brightness is not obtained after manually shortening the exposure duration, the second exposure duration can be shortened again (which still needs to be longer than the first exposure duration) until a more satisfactory scene image is obtained.

In some embodiments, the imaging device 20 may expose for a third exposure duration to capture a scene image, and the third exposure duration is longer than the second exposure duration.

In some scenarios, the user needs to set a relatively long third exposure duration (for example, up to 8 s, or 16 s, etc.) for imaging to cause the scene image to achieve a brilliant light and shadow effect, such as traffic flow, lighting, etc. However, because of a personal physical condition of the user, a time that the user can hold the gimbal 10 and keep a spatial position unchanged is limited, and the time to hold the gimbal 10 and keep the spatial position unchanged is different for different users. Thus, the third exposure duration is limited and a maximum third exposure duration is different for different users, and the user can set a suitable third exposure duration according to personal physical condition. Further, the imaging system 100 may set values of the first exposure duration, the second exposure duration, and the third exposure duration. When the user does not adjust the exposure duration, the imaging system 100 may select different level of the exposure duration according to different amount of incident light. Furthermore, each level of the exposure duration corresponds to a predetermined adjustment range to meet different adjustment needs of the user.

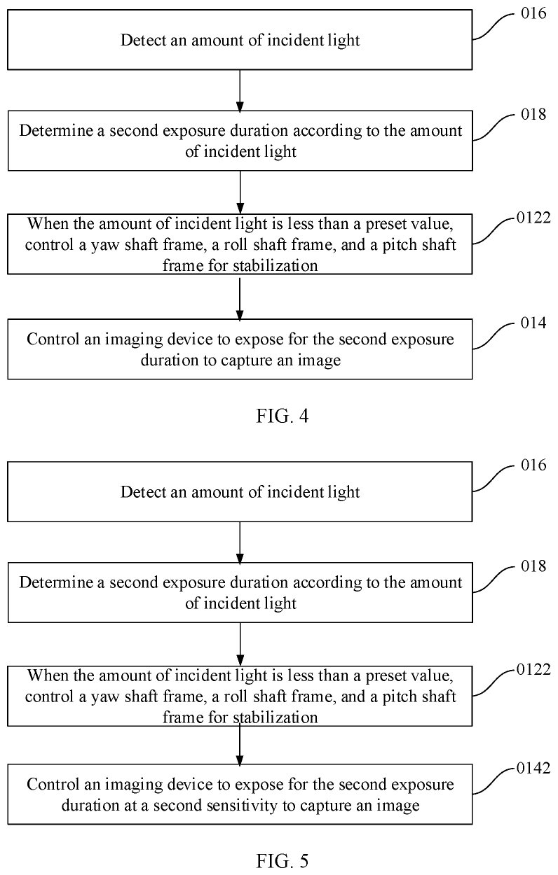

As shown in FIG. 4, in some embodiments, the imaging method further includes following processes.

At 016, the amount of incident light is detected.

At 018, the second exposure duration is determined according to the amount of incident light.

In some embodiments, the imaging device 20 is also used to detect the amount of incident light and determine the second exposure duration according to the amount of incident light.

That is, process 016 and process 018 can be realized by the imaging device 20.

Specifically, the amount of incident light can be determined according to the aperture value of the imaging device 20 and the ambient brightness. When the aperture value is a constant, the higher the ambient brightness (i.e., a bright environment), the greater the amount of incident light. The lower the ambient brightness (i.e., a dark environment), the smaller the amount of incident light. The image sensor 22 of the imaging device 20 detects the amount of incident light entering the imaging device 20 in real time. The image sensor 22 needs a certain amount of light to form a clear scene image. When the amount of incident light is relatively low (corresponding to a dark environment), the second exposure duration needs to be set relatively long to ensure that the total amount of light meets the requirement of the image sensor 22 for a clearer scene image. When the amount of incident light is relatively high (corresponding to a bright environment), the second exposure duration does not need to be set too long to ensure that the total amount of light meets the requirement of the image sensor 22 for a clearer scene image. Therefore, the second exposure duration can be set different according to different amounts of incident light to ensure that the total amount of light received by the imaging device 20 is sufficient for a clear scene image, and the captured scene image is neither too dark nor too bright, thereby ensuring the imaging quality.

As shown in FIG. 5, in some embodiments, when the amount of incident light is greater than the preset value, the imaging device 20 can expose at a first sensitivity to capture a scene image, and process 014 further includes controlling the imaging device 20 to expose for the second exposure duration at a second sensitivity lower than the first sensitivity to capture a scene image (process 0142).

In some embodiments, the imaging device 20 is also used to expose for the second exposure duration at the second sensitivity to capture a scene image, and the second sensitivity is lower than the first sensitivity.

That is, process 0142 can be realized by the imaging device 20.

Specifically, to capture a brighter scene image, the imaging device 20 needs to receive more incident light, and the imaging device 20 usually exposes at a relatively large sensitivity. However, because the relatively large sensitivity may cause more noise, the captured scene image may also be unsatisfactory. In some embodiment, when the amount of incident light is greater than the preset value (corresponding to a bright environment), the imaging device 20 can expose at the first sensitivity to capture a scene image, and the imaging device 20 can obtain sufficient light by setting a smaller sensitivity in a bright environment. When the amount of incident light is less than the preset value (corresponding to a dark environment), the imaging device 20 can expose for the second exposure duration at the second sensitivity to capture a scene image. Because the exposure duration is relatively long, even if the sensitivity is reduced to the second sensitivity lower than the first sensitivity, the imaging device 20 can still obtain sufficient light. The smaller sensitivity causes less noise of the scene image, and the captured scene image can meet the requirement of the brightness and have less noise. That is, the scene image quality is higher.

In some embodiments, the imaging device 20 can expose at the first sensitivity to capture a scene image when the amount of incident light is greater than the preset value (corresponding to a bright environment), the imaging device 20 can expose for the second exposure duration at the second sensitivity to capture a scene image when the amount of incident light is less than or equal to the preset value (corresponding to a dark environment). Alternately, the imaging device 20 can expose at the first sensitivity to capture a scene image when the amount of incident light is greater than or equal to the preset value (corresponding to a bright environment), and the imaging device 20 can expose for the second exposure duration at the second sensitivity to capture a scene image when the amount of incident light is less than the preset value (corresponding to a dark environment). Thus, the imaging method can be executed correctly when the amount of incident light is greater than, equal to, or less than the preset value (corresponding to a bright environment).

In some embodiments, the second sensitivity is negatively correlated with the second exposure duration.

Specifically, the lower the sensitivity, the greater the total amount of light required by the imaging device 20 for imaging. If the amount of incident light is a constant, the second exposure duration needs to be set longer to obtain sufficient light to ensure the imaging device 20 to capture a clear scene image. Conversely, the higher the sensitivity, the smaller the total amount of light required by the imaging device 20 for imaging. Therefore, the imaging device 20 can also obtain sufficient light for imaging with a shorter second exposure duration. Therefore, according to the negative correlation between the second sensitivity and the second exposure duration, when the second sensitivity is set to be lower, the second exposure duration needs to be set longer to ensure that the imaging device 20 obtains sufficient total light to capture a high-quality scene image with less noise.

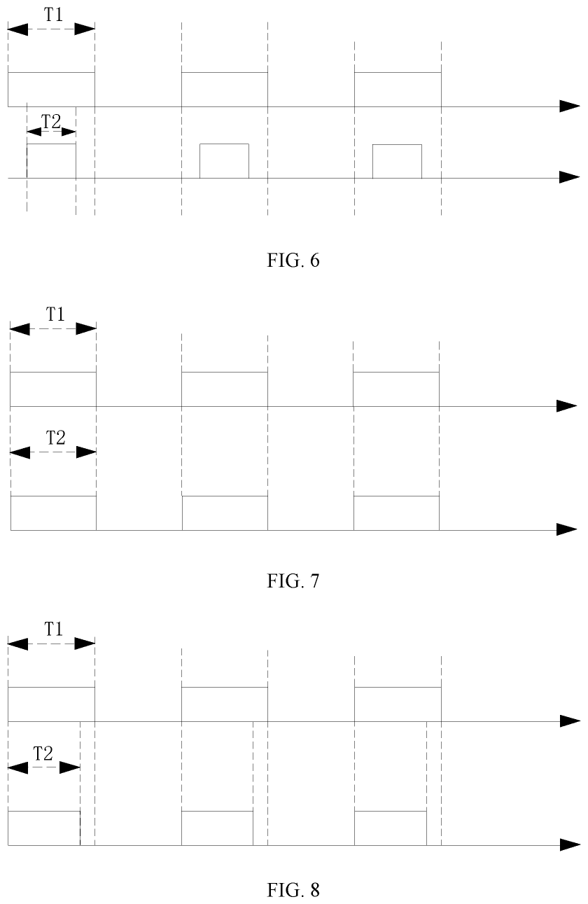

FIG. 6 to FIG. 9 are schematic diagrams showing locking duration and a second exposure duration consistent with embodiments of the disclosure.

As shown in FIG. 6, in some embodiments, a second exposure duration T2 is within a range of a locking duration T1 of the gimbal 10.

Specifically, when the amount of incident light is less than the preset value, the gimbal 10 enters the three-axis stabilization mode. A period of time for the gimbal 10 being under the three-axis stabilization mode is the locking duration T1. The second exposure duration T2 is within the range of the locking duration T1 of the gimbal 10 to ensure that any shaking by the user during the second exposure duration T2 can be offset by the gimbal 10, thereby ensuring the quality of the captured scene image.

As shown in FIG. 7, in some embodiments, a start time of a second exposure duration T2 is same as a start time of a locking duration T1, and an end time of the second exposure duration T2 is same as an end time of the locking duration T1.

Specifically, the gimbal 10 enters the three-axis stabilization mode when the imaging device 20 starts to expose for the second exposure duration T2, and the gimbal 10 exits the current three-axis stabilization mode when the second exposure duration T2 ends. The locking duration T1 and the second exposure duration T2 start and end at the same time, which not only ensures that the gimbal 10 is stably stabilized when the imaging device 20 performs imaging with the second exposure duration T2 to ensure the quality of the captured scene image, but also ensures that the user can normally use the gimbal 10 under another mode, such as the following mode or the tracking mode, after the imaging device 20 captures the current scene image.

As shown in FIG. 8, in some embodiments, a start time of a second exposure duration T2 is same as a start time of a locking duration T1, and an end time of the second exposure duration T2 is earlier than an end time of the locking duration T1.

Specifically, the gimbal 10 enters the three-axis stabilization mode when the imaging device 20 starts to expose at the second exposure duration T2, and the gimbal 10 exit the current three-axis stabilization mode at a time later than the end time of the second exposure duration T2. That is, the gimbal 10 exits the current three-axis stabilization mode after a period of time after the imaging device 20 exposes for the second exposure duration T2 to capture a scene image to leave a certain redundant time, thereby ensuring that the gimbal 10 is stably stabilized when the imaging device 20 performs imaging with the second exposure duration period T2, and ensuring the quality of the captured scene image.

As shown in FIG. 9, in some embodiments, a start time of a second exposure duration T2 is later than a start time of a locking duration T1, and an end time of the second exposure duration T2 is same as an end time of the locking duration T1.

Specifically, the gimbal 10 enters the three-axis stabilization mode before the start time of the second exposure duration T2 to reserve sufficient time for the gimbal 10 to enter the three-axis stabilization mode before the start time of the second exposure duration T2. Therefore, the gimbal 10 can be prevented from actually entering the three-axis stabilization mode later than the start time of the second exposure duration T2 because the gimbal 10 needs some time to actually enter the three-axis stabilization mode when the start time of the second exposure duration T2 is same as the start time of the locking duration T1, which may affect the stabilization effect of the gimbal 10 when the imaging device 20 performs imaging with the second exposure duration T2. The end time of the second exposure duration T2 is same as the end time of the locking duration T1, which can ensure that the user can normally use the gimbal 10 under another mode, such as the following mode or the tracking mode, after the imaging device 20 captures the current scene image.

As shown in FIG. 6, in some embodiments, a start time of the second exposure duration T2 is later than a start time of the locking duration T1, and an end time of the second exposure duration T2 is earlier than an end time the locking duration T1.

Specifically, the gimbal 10 starts the stabilization mode before the start time of the second exposure duration T2 to reserve sufficient time for the gimbal 10 to enter the three-axis stabilization mode before the start time of the second exposure duration T2. Therefore, the gimbal 10 can be prevented from actually entering the three-axis stabilization mode later than the start time of the second exposure duration T2 because the gimbal 10 needs some time to actually enter the three-axis stabilization mode when the start time of the second exposure duration T2 is same as the start time of the locking duration T1, which may affect the stabilization effect of the gimbal 10 when the imaging device 20 performs imaging with the second exposure duration T2. The gimbal 10 exit the current three-axis stabilization mode at a time later than the end time of the second exposure duration T2. That is, the gimbal 10 exits the current three-axis stabilization mode after a period of time after the imaging device 20 exposes for the second exposure duration T2 to capture a scene image to leave a certain redundant time, thereby ensuring that the gimbal 10 is stably stabilized when the imaging device 20 performs imaging with the second exposure duration period T2, and ensuring the quality of the captured scene image.

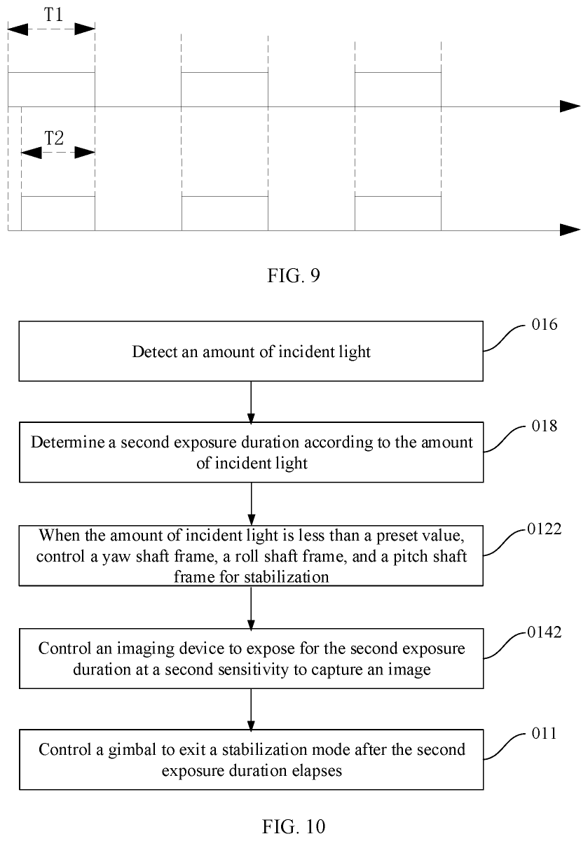

FIG. 10 to FIG. 12 are schematic flow charts of imaging methods consistent with embodiments of the disclosure.

As shown in FIG. 10, in some embodiments, the imaging method further includes controlling the gimbal 10 to exit the stabilization mode after the second exposure duration elapses (process 011).

In some embodiments, the gimbal 10 exits the stabilization mode after the second exposure duration elapses.

That is, process 011 can be realized by the gimbal 10.

Specifically, after the user finishes imaging, the user may sometimes want to switch the working mode of the gimbal 10 to another working mode, for example, the following mode, to adjust an angle to image for a new scene. Therefore, after the second exposure duration elapses, that is, after the imaging device 20 captures a scene image, the gimbal 10 exits the stabilization mode (specifically, the three-axis stabilization mode). A manner for the gimbal 10 to exit the three-axis stabilization mode may be that the gimbal 10 automatically exits the three-axis stabilization mode according to a signal sent by the imaging device 20 indicating completion of the imaging. The way for the gimbal 10 to exit the three-axis stabilization mode may also be that the imaging device 20 controls the gimbal 10 to exit the three-axis stabilization mode after receiving a signal indicating the completion of the imaging. After the gimbal 10 exits the three-axis stabilization mode, the user can manually switch the working mode of the gimbal 10 to another working mode (e.g., the following mode, the tracking mode, etc.). If the user does not manually switch the working mode of the gimbal 10, the gimbal 10 can switch the working mode according to the working mode of the gimbal 10 before the start time of the locking duration. For example, if the working mode of the gimbal 10 is the following mode before the start time of the locking duration, the three-axis stabilization mode is switched to the following mode. For another example, if the working mode of the gimbal 10 is the tracking mode before the start time of the locking duration, the three-axis stabilization mode is switched to the tracking mode. Therefore, the imaging device 20 is only under the three-axis stabilization mode during the locking duration, and the imaging device 20 can maintain consistency of the working mode before and after the locking duration.

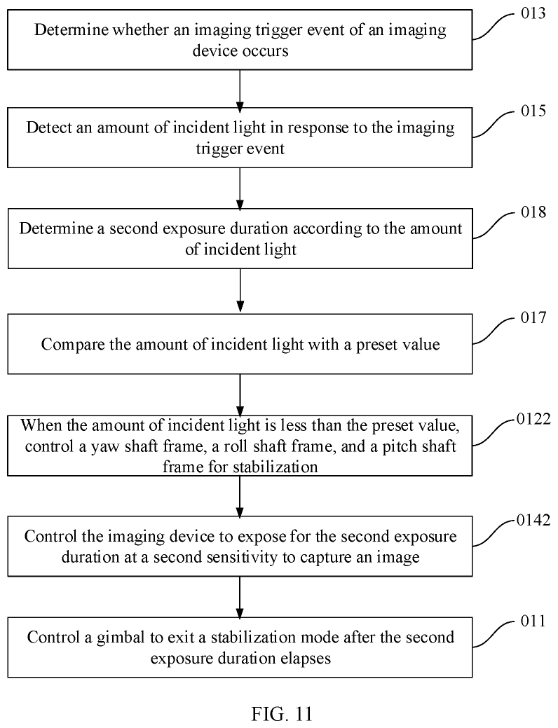

As shown in FIG. 11, in some embodiments, the imaging method further includes following processes.

At 013, whether an imaging trigger event of the imaging device 20 occurs is determined.

At 015, an amount of incident light is detected in response to the imaging trigger event.

At 017, the amount of incident light is compared with the preset value.

In some embodiments, the imaging device 20 is used to determine whether an imaging trigger event of the device 20 occurs. When the imaging trigger event occurs, the imaging device 20 detects the amount of incident light. The imaging device 20 is also used to compare the amount of incident light with the preset value.

That is, processes 013, 015, and 017 can be realized by the imaging device 20.

Specifically, the imaging device 20 determines whether an imaging trigger event occurs. For example, an imaging button is provided at the imaging device 20, and the imaging event is triggered when the user presses the imaging button. For another example, the handle 11 of the gimbal 10 is provided with an imaging control button. When the user presses the imaging control button, the gimbal 10 controls the imaging device 20 to capture a scene image to trigger an imaging event. For another example, the handle 11 of the gimbal 10 is provided with a touch screen, which can not only display the imaging in real time, but also start an imaging function, such as imaging an object, or self-timer, etc., via a touch operation, such as frame selection, single-click, double-click, etc. The imaging device 20 may also use another method (such as setting an imaging remote control button at a remote control device communicatively connected with the imaging device 20, and the user presses the imaging remote control button to trigger an imaging event) to determine whether an imaging trigger event occurs. The implementation method to determine whether an imaging trigger event occurs is not limited here. After the imaging device 20 determines that an imaging trigger event occurs, the image sensor 22 of the imaging device 20 detects the amount of incident light, and then the imaging device 20 compares the amount of incident light with the preset value. The gimbal 10 enters the stabilization mode when the amount of incident light is less than the preset value. The imaging device 20 exposes for the second exposure duration to capture a scene image. Therefore, the imaging trigger event is used to accurately determine whether the user performs imaging. When the user performs the imaging and the amount of incident light is less than the preset value, the gimbal 10 enters the stabilization mode, and the imaging device 20 exposes for the second exposure duration to capture a scene image, therefore achieving better scene image quality for imaging in a dark environment.

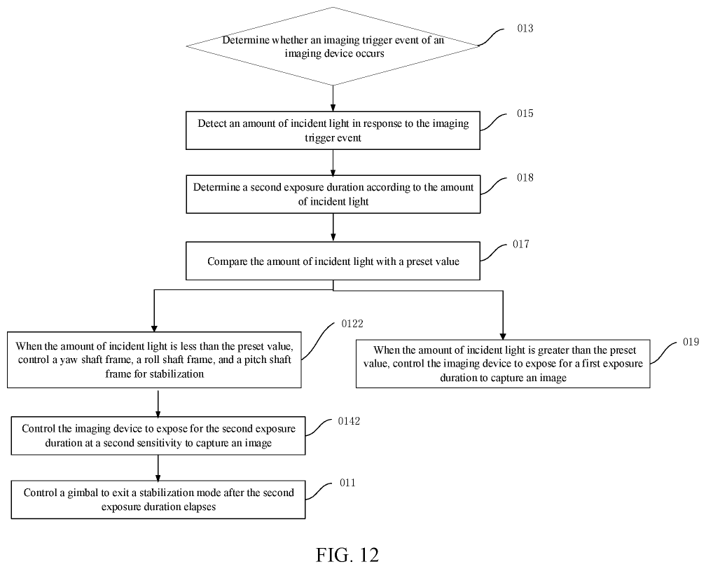

As shown in FIG. 12, in some embodiments, the imaging method further includes that the imaging device 20 exposes for the first exposure duration to capture a scene image when the amount of incident light is greater than the preset value (process 019).

In some embodiments, when the amount of incident light is greater than the preset value, the imaging device 20 exposes for the first exposure duration to capture a scene image.

That is, the process 019 can be realized by the imaging device 20.

Specifically, when the amount of incident light is greater than the preset value, that is, in a bright environment, because the light is sufficient currently, sufficient light can also be obtained when the user uses the first exposure duration, which is relatively short, to perform exposure to capture a scene image. In this scenario, the gimbal 10 can maintain the current working mode (such as the following mode) rather than enter the three-axis stabilization mode to capture a scene image normally. Because the first exposure duration is relatively short, which is generally ⅛ s, or 1/16 s, etc., the impact of the shaking by the user on imaging can be ignored. Therefore, the better imaging quality can be achieved by using different exposure duration in a bright environment and in a dark environment.

In the description of the specification, the terms “an embodiment,” “some embodiments,” “example embodiments,” “example,” “specific example,” or “some examples” etc. refer to that the described specific features, structures, materials, or characteristics described in the embodiments or examples are included in at least one embodiment or example of the present disclosure. In this specification, the schematic representation of the above terms may not refer to the same embodiment or example. Moreover, the described specific features, structures, materials, and characteristics can be combined in any one or more embodiments or examples in a suitable manner.

The descriptions of processes or methods in the flow charts or described in other ways herein can be understood as a module, segment, or part of code that includes one or more executable instructions for performing specific logical functions or processes. It is understood by those skilled in the art that the additional executions, which may not be in the order shown or described, including the execution of the functions in a substantially simultaneous manner or in the reverse order according to the functions thereof, are within the scope of the present disclosure.

The logic and/or processes shown in the flow chart or described in other ways herein, for example, can be considered as a sequenced list of executable instructions for executing logic functions, and can be specifically executed in a computer-readable medium, for using by a instruction execution system, device, or equipment (such as a computer-based system, a system including a processor 22 (shown in FIG. 1), or another system that can fetch and execute instructions from the instruction execution system, device, or equipment), or in combination with the instruction execution systems, device, or equipment. The computer-readable medium can be any device that can contain, store, communicate, propagate, or transmit a program for using by an instruction execution system, device, or device, or in combination with the instruction execution system, device, or equipment, for example, an electrical connection member (electronic device) with one or more wiring, a portable computer disk (magnetic device), a random-access memory (RAM), a read-only memory (ROM), an erasable programmable read-only memory (EPROM or flash memory), a fiber optic device, or a compact disk read-only memory (CD-ROM). In addition, the computer-readable medium may even be paper or other suitable medium on which the program can be printed, because it can be used, for example, by optically scanning the paper or other medium, followed by editing, interpretation, or other suitable processing to obtain the program electronically and then stored in a computer memory.

Each part of the present disclosure can be implemented by hardware, software, firmware, or a combination thereof. In the above embodiments, a plurality of processes or methods can be executed by software or firmware stored in a memory and executed by a suitable instruction execution system. For example, if the process or method is performed by hardware, it can be performed by any one or a combination of the following technologies known by those skilled in the art, such as a discrete logic circuit including a gate circuit for performing logic functions on digital signals, a specific integrated circuit with suitable combinational logic gates, a programmable gate array (PGA), a field programmable gate array (FPGA), etc.

Those skilled in the art can understand that some or all of the processes in the above implementation method can be executed by a program instructing relevant hardware to complete. The program can be stored in a computer-readable storage medium. When the program is executed to perform one or more of the processes of the method consistent with the embodiments or a combination thereof.

In addition, the functional units in the various embodiments of the present disclosure may be integrated into one processing unit, or each unit may be an individual physically unit, or two or more units may be integrated into one unit. The above-described integrated unit can be executed in the form of hardware or a software function module. If the integrated unit is executed in the form of a software function unit, which can be sold or used as a standalone product, it may also be stored in a computer-readable storage medium.

The computer-readable storage medium may be a ROM, a magnetic disk, or an optical disk, etc. Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. An imaging method comprising:
controlling a gimbal carrying an imaging device to enter a stabilization mode in response to an amount of incident light being less than a preset value, the imaging device being configured to perform imaging with a first exposure duration in response to the amount of incident light being greater than the preset value; and
controlling the imaging device to perform imaging with a second exposure duration longer than the first exposure duration.

2. The imaging method of claim 1, wherein:
the gimbal includes a yaw shaft frame, a roll shaft frame, and a pitch shaft frame; and
controlling the gimbal to enter the stabilization mode includes controlling the yaw shaft frame, the roll shaft frame, and the pitch shaft frame for stabilization.

3. The imaging method of claim 1, wherein the second exposure duration is manually set or adjusted by a user.

4. The imaging method of claim 1, further comprising:
detecting the amount of incident light; and
determining the second exposure duration according to the amount of incident light.

5. The imaging method of claim 1, wherein:
the imaging device is configured to perform imaging at a first sensitivity in response to the amount of incident light being greater than the preset value; and
controlling the imaging device to perform imaging with the second exposure duration includes controlling the imaging device to perform imaging with the second exposure duration at a second sensitivity lower than the first sensitivity.

6. The imaging method of claim 5, wherein the second sensitivity is negatively correlated with the second exposure duration.

7. The imaging method of claim 1, wherein the second exposure duration is within a range of a locking duration of the gimbal.

8. The imaging method of claim 7, wherein a start time of the second exposure duration is same as a start time of the locking duration, and an end time of the second exposure duration is same as an end time of the locking duration.

9. The imaging method of claim 7, wherein a start time of the second exposure duration is same as a start time of the locking duration, and an end time of the second exposure duration is earlier than an end time of the locking duration.

10. The imaging method of claim 7, wherein a start time of the second exposure duration is later than a start time of the locking duration, and an end time of the second exposure duration is same as an end time of the locking duration.

11. The imaging method of claim 7, wherein a start time of the second exposure duration is later than a start time of the locking duration, and an end time of the second exposure duration is earlier than an end time of the locking duration.

12. The imaging method of claim 1, further comprising:
controlling the gimbal to exit the stabilization mode after the second exposure duration elapses.

13. The imaging method of claim 1, further comprising:
determining whether an imaging trigger event of the imaging device occurs;
detecting the amount of incident light in response to the imaging trigger event; and
comparing the amount of incident light with the preset value.

14. The imaging method of claim 13, further comprising:
controlling the imaging device to perform imaging with the first exposure duration in response to the amount of incident light being greater than the preset value.

15. An imaging system comprising:
a gimbal configured to enter a stabilization mode in response to an amount of incident light being less than a preset value; and
an imaging device mounted at the gimbal and configured to:
perform imaging at a first exposure duration in response to the amount of incident light being greater than the preset value; and
perform imaging at a second exposure duration longer than the first exposure duration in response to the amount of the incident light being less than the preset value and the gimbal entering the stabilization mode.

16. The imaging system of claim 15, wherein:
the gimbal includes a yaw shaft frame, a roll shaft frame, and a pitch shaft frame; and
the gimbal is further configured to control the yaw shaft frame, the roll shaft frame, and the pitch shaft frame for stabilization.

17. The imaging system of claim 15, wherein the second exposure duration is manually set or adjusted by a user.

18. The imaging system of claim 15, wherein the imaging device is further configured to detect the amount of incident light and determine the second exposure duration according to the amount of incident light.

19. The imaging system of claim 15, wherein the imaging device is further configured to:
perform imaging at a first sensitivity in response to the amount of incident light being greater than the preset value; and
perform imaging with the second exposure duration at a second sensitivity lower than the first sensitivity in response to the amount of incident light being less than the preset value.

20. The imaging system of claim 15, wherein the gimbal includes a handheld gimbal including:
a handle configured to communicate with the imaging device to control the imaging device to perform imaging with the second exposure duration under the stabilization mode; and
at least one shaft frame mounted at the handle and configured to carry the imaging device and keep the imaging device at a stable attitude under the stabilization mode.
